(19) United States
(12) Patent Application Publication
(10) Pub. No.: US 2010/0286809 A1
(43) Pub. Date: Nov. 11, 2010

(54) ANALYTICAL MODEL GENERATING APPARATUS

(76) Inventors: Ichiro KATAOKA, Hitachinaka (JP); Ichiro Nishigaki, Ishioka (JP); Takashi Yokohari, Bando (JP); Masayuki Hariya, Kasumigaura (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/775,811

(22) Filed: May 7, 2010

(30) Foreign Application Priority Data
May 11, 2009 (JP) JP2009-114111

(51) Int. Cl. G06F 17/00

(52) U.S. Cl. 700/99; 700/212

(57) ABSTRACT

An analytical model generating-apparatus including: an input portion which inputs CAD data describing at least a first part and a second part, face-to-face angle threshold data, face-to-face distance threshold data, and leg length data of a welding bead; a CAD data reading-portion; a welding bead retrieving-portion comparing an angle between the first part and the second part with the face-to-face angle threshold data so as to retrieve a place where the welding bead should be produced; a clearance checking-portion comparing a distance between the first part and the second part with the face-to-face distance threshold data; a virtual shape creating-portion creating a virtual shape in the clearance between the first part and the second part; a welding bead producing-portion producing the welding bead in the virtual shape based on the leg length data of the welding bead; and a CAD data saving-portion saving CAD data including the produced welding bead.

### INCORPORATION BY REFERENCE

The present application claims priority from Japanese application JP2009-114111 filed on May 11, 2009, the content of which is hereby incorporated by reference into this application.

### BACKGROUND OF THE INVENTION

1. Field of the Invention

The present invention relates to an analytical model generating apparatus which adds processing information to CAD data for design and creates CAD data for analysis.

2. Description of the Related Art

In recent years, technology for automatically generating data for analysis including mesh data has been developed. Technology for automatically creating mesh data for analysis in CAE from data for design leads to shortening the model creation time and the analysis time and offers the key to provide an analysis-driven design for designing while carrying out analysis.

On the other hand, at designing sites, data for design, data for analysis and data for production are created independently of one another, or the data for design is managed in division's own form such as 3D CAD data or drawings. In addition, no information about instructions of welding etc. written in drawings is given to the 3D CAD data. Accordingly, when a user performs analysis, the user must visually find out places to be welded, and manually create shapes of welding beads or the like in the places to be welded.

Thus, many man-hours are required for the work of finding out places to be welded and creating welding shapes. In addition, it takes much time for the analysis work. It therefore takes much time for a cycle of steps of design, analysis and change of the design based on a result of the analysis. Particularly in a large-scale model, more places to be welded lead to increase in man-hours for finding out the places to be welded and creating welding shapes.

JP-A-11-291039 has disclosed a method in which places where faces of parts abut against each other are automatically found out, from CAD data, as portions of the parts to be bonded with each other, that is, places to be welded, and lines forming any shared plane are presented to a user, in order to create welding information.

In the method disclosed in JP-A-11-291039, any place can be concluded as a place to be welded only if faces of parts abut against each other in that place. For example, there is no description at all on whether a place can be recognized as a place to be welded if a face of one part abuts against a line of another part in that place or if parts are designed to be spaced with a clearance.

### SUMMARY OF THE INVENTION

The present invention was developed in consideration of the aforementioned problem. An object of the invention is to provide an analytical model generating apparatus which can shorten the work time of creating a welding bead.

In order to attain the foregoing object, the invention provides an analytical model generating apparatus including: an input portion which inputs CAD data describing at least a first part and a second part, face-to-face angle threshold data, face-to-face distance threshold data, and leg length data of a welding bead; a CAD data reading portion which reads the CAD data; a welding bead retrieving portion which compares an angle between the first part and the second part with the face-to-face angle threshold data so as to retrieve a place where the welding bead should be produced; a clearance check portion which compares a distance between the first part and the second part with the face-to-face distance threshold data; a virtual shape creating portion which creates a virtual shape in the clearance between the first part and the second part based on comparison results of the welding bead retrieving portion and the clearance check portion; a welding bead producing portion which produces the welding bead in the virtual shape based on the leg length data of the welding bead; and a CAD data saving portion which saves CAD data including the produced welding bead.

The virtual shape creating portion may extend one of a first face of the first part and a second face of the second part to the other so as to create the virtual shape.

The analytical model generating apparatus may include a virtual shape deleting portion which deletes at least a part of the virtual shape located outside the produced welding bead when at least the part of the virtual shape is located outside the welding bead.

The welding bead retrieving portion may retrieve the angle between the first part and the second part based on an angle between a first face of the first part and a second face of the second part.

In addition, the invention provides an analytical model generating apparatus including: a CAD data reading portion which reads CAD data; a welding bead retrieving portion which retrieves, from the CAD data, a place where a welding bead should be produced; a clearance check portion which checks whether there is or not a clearance in the retrieved place where the welding bead should be produced; a virtual shape creating portion which creates a virtual shape in the clearance; a welding bead producing portion which produces the welding bead in the virtual shape; and a CAD data saving portion which saves CAD data including the produced welding bead.

According to the invention, it is possible to provide an analytical model generating apparatus which can shorten the work time of producing a welding bead.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing a system according to a first embodiment;

FIG. 2 is a diagram showing an example of a data flow;

FIG. 3 is a diagram showing an example of a flow chart;

FIG. 4 is a diagram showing an example of a process for retrieving a portion to be welded;

FIG. 5 is a diagram showing an example of a process for retrieving a clearance between parts;

FIG. 6 is a diagram showing an example in which a virtual shape is created in accordance with the type of the clearance;

FIG. 7 is a diagram showing an example of a process for creating a virtual shape;

FIG. 8 is a diagram showing an example of a process for producing a welding bead;

FIG. 9 is a diagram showing an example of a process for deleting a virtual shape after producing a welding bead;

FIG. 10 is a diagram showing an example of an operation screen;

FIG. 11 is a diagram showing an example of an operation screen;

FIG. 12 is a diagram showing an example of an operation screen;

FIG. 13 is a diagram showing an example of an operation screen;

FIG. 14 is a diagram showing an example of an operation screen;

FIG. 15 is a diagram showing an example of an operation screen;

FIG. 16 is a diagram showing an example of an operation screen;

FIG. 17 is a diagram showing an example of an operation screen;

FIG. 18 is a diagram showing an example of an operation screen;

FIG. 19 is a diagram showing an example of an operation screen;

FIG. 20 is a diagram showing an example of an operation screen; and

FIG. 21 is a diagram showing an example of an operation screen.

### DETAILED DESCRIPTION OF THE INVENTION

A first embodiment will be described below.

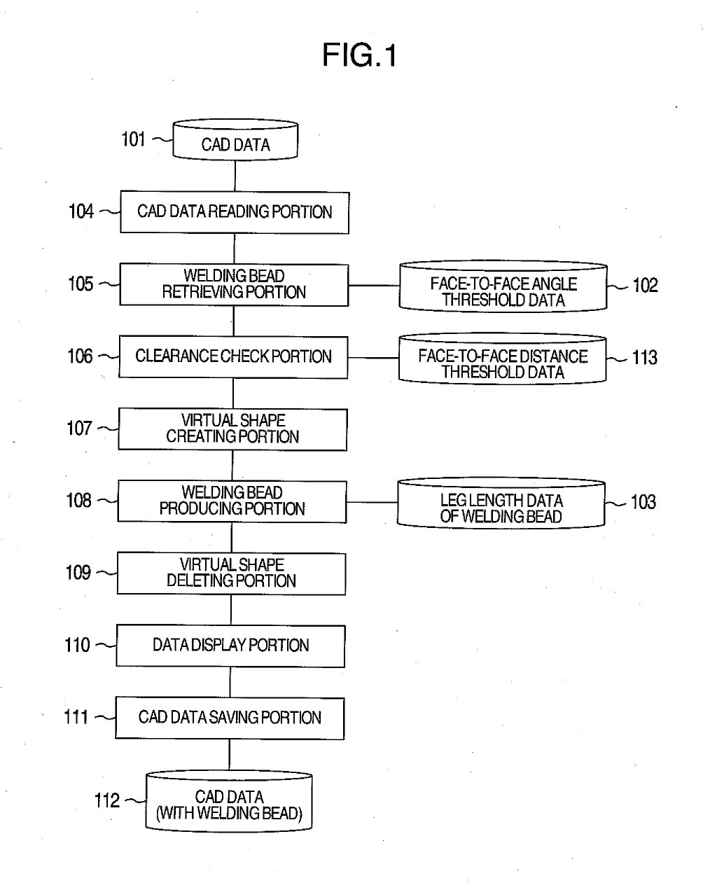

FIG. 1 is a diagram showing a system according to the first embodiment. This system has CAD data 101, face-to-face angle threshold data 102, face-to-face distance threshold data 113, and welding bead leg length data 103 as input data. The face-to-face angle threshold data 102 shows an angle between a first face of a first part and a second face of a second part. The face-to-face distance threshold data 113 shows a distance between the first face and the second face. At least CAD data describing the first part and the second part is read by a CAD data reading portion 104. From the read CAD data, a welding bead retrieving portion 105 retrieves a place where a welding bead should be produced, based on an angle between those parts and the face-to-face angle threshold data 102. The result of the retrieval is highlight-displayed. The words “highlight-display” means display with lines whose color, thickness or the like is different from that of any other line or display of a part with diagonal lines. The same thing will be applied to the following description. When a welding bead is retrieved, there may be a clearance at a place where the welding bead should be produced. In this case, a clearance check portion 106 calculates a face-to-face distance between the first part and the second part and checks whether there is a clearance or not, using the face-to-face distance threshold data 113 for retrieving the place where the welding bead should be produced. When a clearance not larger than a face-to-face distance threshold is present between the first part and the second part, boundary planes and lines between the first part and the second part are highlight-displayed. For the clearance, a virtual shape creating portion 107 creates a virtual shape for filling the clearance, and retrieves a shared line between the first face of the first part and the second face of the second part in order to produce the welding bead. When the leg length of the welding bead is inputted for the place where the welding bead should be produced, that is, for the shared line between the first face and the second face, a welding bead producing portion 108 produces the welding bead on the shared line between the first face and the second face, and displays the welding bead. Any produced welding bead can be produced or deleted correspondingly to its name. The virtual shape created to fill the clearance does not have to stay inside the produced welding bead but may penetrate the welding bead to the outside. In such a case, a virtual shape deleting portion 109 deletes the part of the virtual shape located outside the welding bead. A data display portion 110 displays the result in which the welding bead has been produced and the excessive part of the virtual shape has been deleted. A CAD data saving portion 111 saves CAD data 112 where the welding bead has been produced.

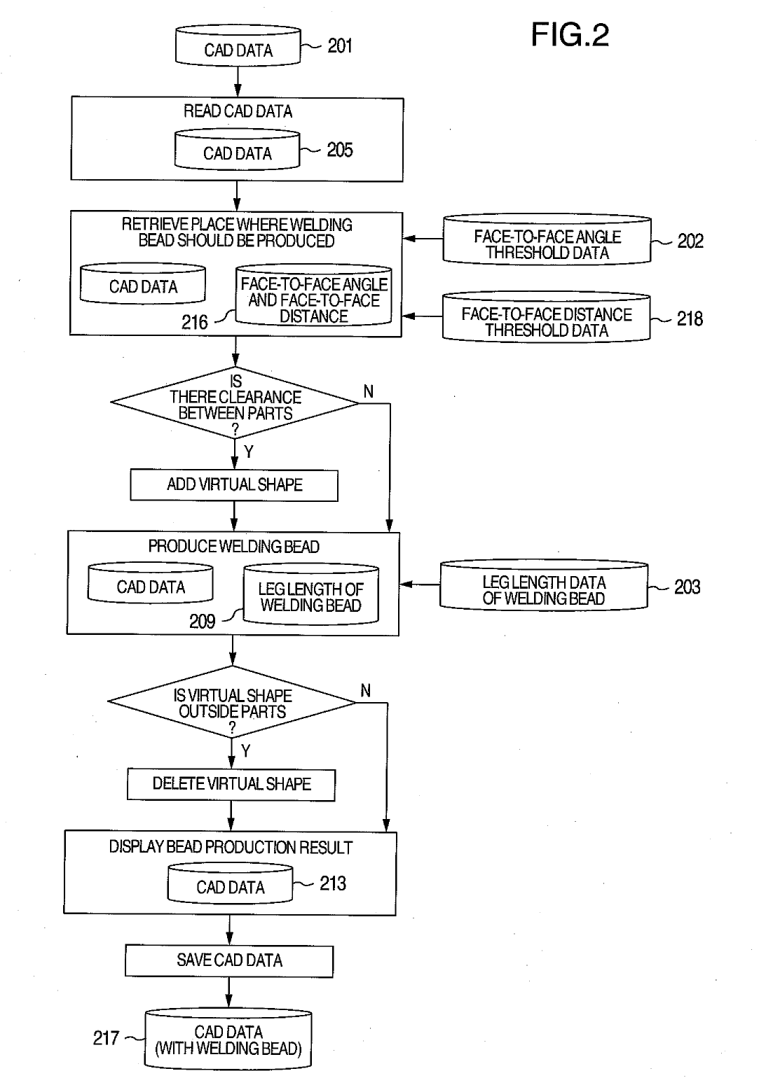

FIG. 2 is a diagram showing a processing process and a data flow for retrieving a place where a welding bead should be produced, and producing the welding bead. The CAD data reading portion 104 reads CAD data 201. From the read CAD data 205, the welding bead retrieving portion 105 retrieves a place to which processing information of a welding bead or the like should be added, using face-to-face angle threshold data 202 set by a user. The welding bead retrieving portion 105 next compares an angle between a first part and a second part with the face-to-face angle threshold data 202 set by the user. The clearance check portion 106 compares a distance between a first face and a second face with face-to-face distance threshold data 218. A place where a welding bead should be produced is obtained based on the results of comparison in the welding bead retrieving portion 105 and the clearance check portion 106. On this occasion, whether there is a clearance between the first part and the second part or not is determined from the angle (face-to-face angle) and distance (face-to-face distance) 216 between the first face and the second face. When there is a clearance between the first part and the second part, the virtual shape creating portion 107 creates a virtual shape on the CAD data and fills the clearance with the virtual shape in order to produce the welding bead in the clearance. After that, the welding bead producing portion 108 adds the processing information of the welding bead or the like and produces the welding bead, based on the result of retrieval of the place where the welding bead should be produced and leg length data 203 of the welding bead. When the welding bead is produced, information about the shape and leg length 209 of the welding bead is added. In addition, information such as a welding bead start position, a welding pitch, a welding current or a welding speed can be added. After the welding bead is produced, the virtual shape deleting portion 109 determines whether the virtual shape created to fill the clearance therewith stays outside the welding bead or on the shape thereof, or not. When the virtual shape stays outside the welding bead, the first part and the second part, the virtual shape is deleted in the boundary plane between the virtual shape and the welding bead, the boundary plane between the virtual shape and the first part and the boundary plane between the virtual shape and the second part. After the virtual shape is deleted, the data display portion 110 displays CAD data 213 to which the welding bead has been added. The CAD data saving portion 111 saves CAD data 217 to which the virtual shape has been added.

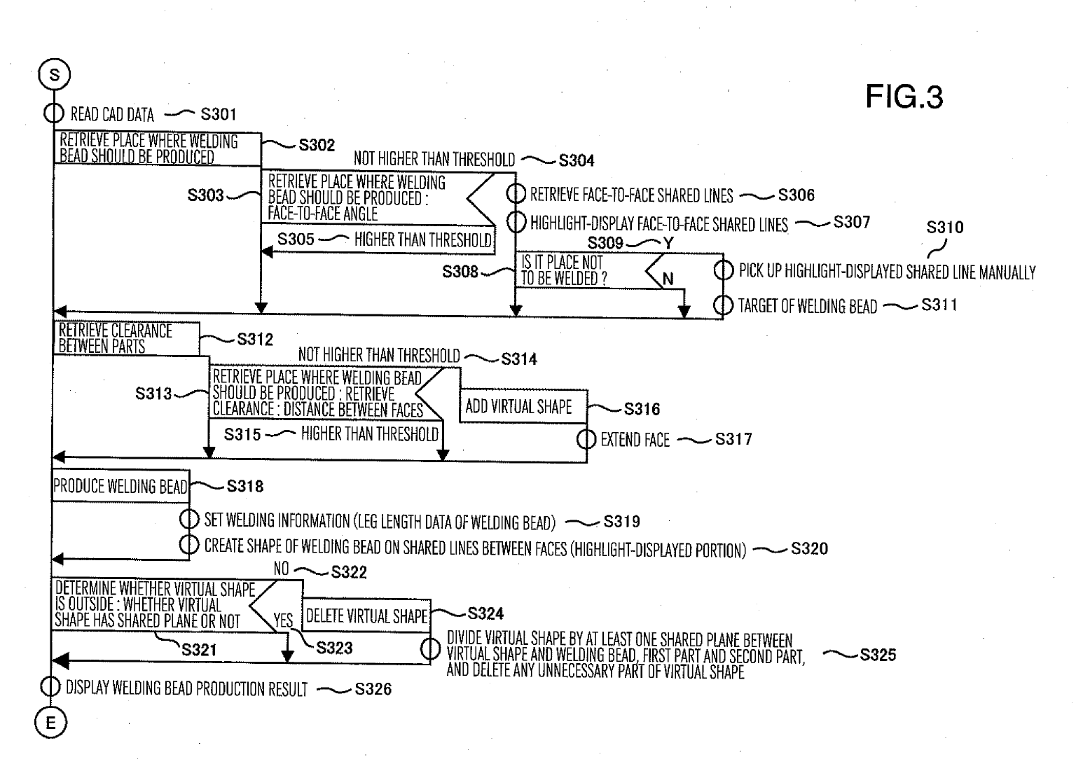

FIG. 3 is a diagram showing processing for producing a welding bead on CAD data. CAD data is first read (S301), and a place where a welding bead should be produced is retrieved (S302). When a place where a welding bead should be produced is retrieved (S303), whether an angle between a first face of a first part and a second part of a second part stays within a threshold set by a user or not is determined based on information of the first face and the second face (S304 and S305). When the angle between the first face and the second face stays within the set angle threshold, the angle between the first face and the second face is retrieved, the welding bead is produced on shared lines between the first face and the second face, and the shared lines are highlight-displayed (S306 and S307). Whether the highlight-displayed shared lines should be added or not may be set manually by the user viewing the screen. Specifically, one of the highlight-displayed shared lines between the first face and the second face is selected on the screen (S310) and set as not-eligible to produce the welding bead thereon. When set as not-eligible, the shared line set as not-eligible to produce the welding bead thereon is no longer highlight-displayed (S311).

On the other hand, when a welding bead is produced in the clearance between the first part and the second part, a place where the welding bead should be produced can be retrieved indeed based on the angle between the first face of the first part and the second face of the second part, but the welding bead cannot be provided directly in the clearance. In CAD data, a clearance is often secured for a welding place in consideration of tolerance among parts. For this reason, the welding bead cannot be provided directly in such a clearance. Therefore, the user creates a shape which is originally absent from the CAD data, as a virtual shape, and fills the clearance between the first part and the second part with the virtual shape. After that, the welding bead is produced in the virtual shape. When the clearance between the first part and the second part is retrieved (S312), the clearance between the first part and the second part is obtained from the distance between the first face of the first part and the second face of the second part. When the obtained clearance is not larger than a face-to-face distance threshold set by the user, a virtual shape is created to fill the clearance. The retrieved clearance between the first part and the second part is calculated from the shortest distance between the first face and the second face (S313). Whether the welding bead should be produced or not is determined in accordance with whether the face-to-face distance is not higher than the threshold (S314) or higher than the threshold (S315). When determination is made that the welding bead should be produced in the clearance, a virtual shape is added to fill the clearance (S316). The virtual shape is created by extending one of the first face and the second face from which the shortest distance was obtained (S317). After the clearance is filled with the virtual shape, the welding bead is produced (S318). To produce the welding bead, the shape of the welding bead is created on shared lines between the first face and the second face where the welding bead should be produced (S320). Welding information such as bead leg length data is set for the welding bead shape (S319). After the welding bead is produced, it is checked whether the virtual shape created to fill the shape of the clearance stays outside the welding bead or not, or outside the first part and the second part or not. When staying outside, the virtual shape is deleted. Whether the virtual shape stays outside the welding bead or not, or outside the first part and the second part or not, is determined in accordance with whether the virtual shape has a shared plane with the welding bead and the first part or a shared plane with the welding bead and the second part, or not (S321). When the virtual shape has no shared plane, it means that the virtual shape stays at least outside the first part or the second part. Of faces forming the virtual shape, any part with no shared plane (outside the welding bead shape, the first part and the second part) is deleted (S324).

As a method for deleting the virtual shape, whether the virtual shape has a shared plane with the welding bead and the first part and a shared plane with the welding bead and the second part is determined, and the virtual shape is divided by the determined shared planes. Of the divided virtual shapes, any virtual shape is deleted when at least one of faces forming the virtual shape has no shared plane (S325). Last, CAD data where the welding bead has been produced is displayed (S326).

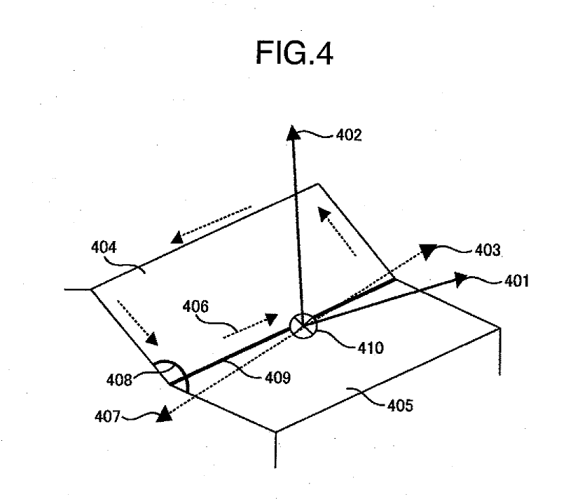

FIG. 4 is a diagram showing an example of a method for retrieving a place where a welding bead should be produced. An angle θ_{bead} between a first face 404 of a first part and a second face 405 of a second part is retrieved. The angle between the first face 404 and the second face 405 is obtained from a normal vector N_{face1} (401) of the first face 404 and a normal vector N_{face2} (402) of the second face 405 at an intermediate point 410 on a shared line 409 between the first face 404 and the second face 405. When an angle θ_{bead} 408 between the normal vector of the first face 404 and the normal vector of the second face 405 is calculated, an angle will be obtained regardless of whether it is convex or concave. In order to recognize the angle as convex or concave, an outer product 407 of the normal vector of the first face 404 and the normal vector of the second face 405 and a tangent vector T_{face1} (tangent vector (403) on the first face 404 side) on the shared line between the first face 404 and the second face 405 are obtained, and the direction of each obtained vector is checked. When the direction of the outer vector coincides with the direction of the tangent vector, there is a convex shape between the first face 404 and the second face 405. Therefore, a case (concave shape) where the directions of the outer vector and the tangent vector do not coincide with each other is to be retrieved. An angle θ_{concave} between the outer vector and the tangent vector is obtained from an inner product of the outer vector and the tangent vector. When a normal vector of a face looks upward in CAD data, the direction of a tangent vector of a line forming the face is often fixed as left-handed 406. The shared line between the first face 404 and the second face 405 has a tangent vector of the first face 404 and a tangent vector of the second face 405. When the tangent vector of the first face 404 is used, an outer product in view from the first face 404 is calculated in the following Expressions 1 and 2.

$$\begin{matrix}cos {θ}_{bead} = \frac{{\vec{N}}_{face 1} \cdot {\vec{N}}_{face 2}}{\vert {\vec{N}}_{face 1} \vert \vert {\vec{N}}_{face 2} \vert} & ( Expression 1 ) \\ cos {θ}_{concave} = \frac{( {\vec{N}}_{face 1} \times {\vec{N}}_{face 2} ) \cdot {\vec{T}}_{face 1}}{\vert {\vec{N}}_{face 1} \times {\vec{N}}_{face 2} \vert \vert {\vec{T}}_{face 1} \vert} & ( Expression 2 )\end{matrix}$$

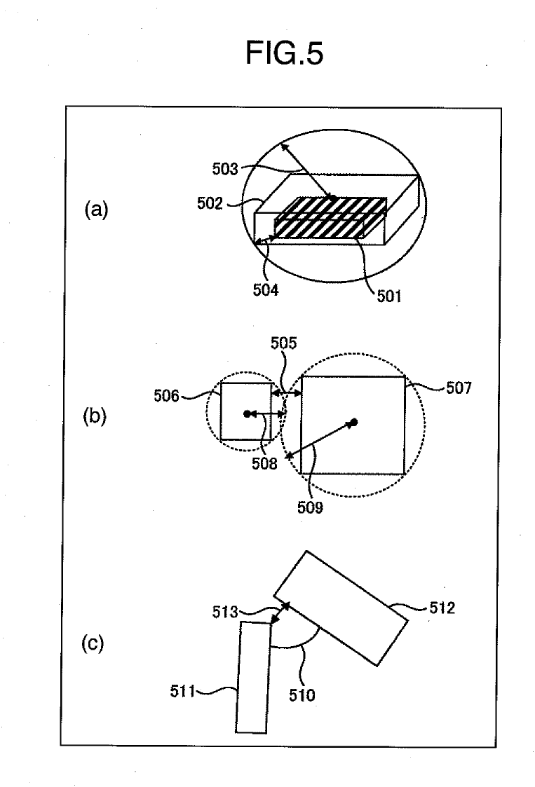

FIG. 5 is a diagram showing an example of a process for retrieving a clearance between parts. A place where a welding bead should be produced is retrieved based on an angle between faces, and the welding bead is produced on a shared line between the faces. However, the shape of the welding bead is absent from the welding place in CAD data, and there is often a clearance between parts in consideration of tolerance. In order to produce a welding bead, a model constituted by a plurality of parts must be modeled into one part (or formed into one body) so that the welding bead can be produced in that state. However, if there is only a slight clearance between parts which must be combined (bonded) into one part, those parts cannot be combined, but a virtual shape must be added to fill the clearance. In the present circumstances, such a clearance between parts is found out visually, and it takes much time to find out the clearance.

A clearance between a first part 506 and a second part 507 is therefore retrieved. Assume that the place to be retrieved is a place where the first part 506 and the second part 507 are not connected but stay within a constant distance (threshold) away from each other (with a clearance). A user sets and inputs a distance with which the first part 506 and the second part 507 are allowed to stay away from each other, for example, a face-to-face distance threshold. When the first part 506 and the second part 507 stay within the face-to-face distance threshold away from each other, a place (e.g. including faces, lines or points of the parts) corresponding thereto is highlight-displayed. According to one of methods for retrieving the clearance between the first part 506 and the second part 507, the shortest distance between a first face of the first part 506 and a second face of the second part 507 is obtained, and determination is made as to whether the obtained shortest distance is within the inputted face-to-face distance threshold or not. A pair of faces may have to be found out among a plurality of parts. In such a case, the processing time will be elongated if the aforementioned determination is applied to any pair of all the faces.

For this sake, a bounding box 502 at a constant distance L 504 from a plane shape 501 is obtained. When a sphere 503 (whose radius is R) containing the bounding box 502 includes another bounding box 502 having a different shape, a face-to-face distance is calculated. When a first sphere 508 (whose radius is R1) in a bounding box of the first part 506 and a second sphere 509 (whose radius is R2) in a bounding box of the second part 507 are included, those parts 506 and 507 are set as parts to calculate a face-to-face distance therebetween, and a distance D 505 is obtained. As for the clearance, retrieval using a distance 513 between the first part 506 and the second part 507 and retrieval using an angle 510 between a first face of the first part 506 and a second face of the second part 507 are combined. For example, only when the first part 506 and the second part 507 lie close to each other but with a clearance therebetween, the clearance can be found out.

After the clearance is retrieved, a virtual shape is added to fill the clearance. In creation of the virtual shape, a pair of faces serving as boundaries of the clearance have been obtained due to the retrieval of the clearance. For example, the following method can be therefore considered for creating the virtual shape. That is, of the paired faces, one with a smaller area is selected, and a line is extended from one point of the selected face and in the normal vector direction of the face, and connected to the other face in order to create the virtual shape. Types of shapes of clearances include a slit and a groove between parts to be welded.

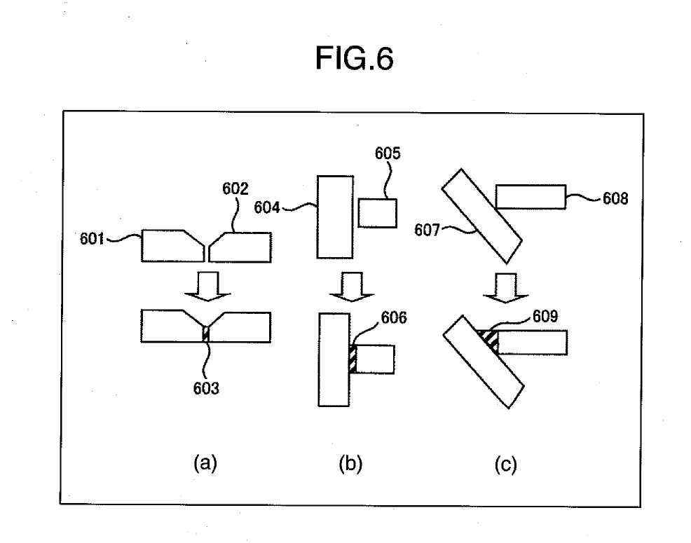

FIG. 6 is a diagram showing an example of processing for adding a virtual shape. For example, for a groove-like shape between a first part 601 and a second part 602, a virtual shape 603 which is absent from original design data is added between a first face of the first part 601 and a second face of the second part 602. Also for a shape where fillet welding should be set between a third part 604 and a fourth part 605, when there is a clearance between the third part 604 and the fourth part 605, a virtual shape 606 is added to fill the clearance. Further, as shown by a fifth part 607 and a sixth part 608, when the fifth part 607 and the sixth part 608 abut obliquely against each other, or when a welding bead should be produced in a shape where the fifth part 607 and the six part 608 are disposed obliquely at a slight distance from each other, a virtual shape 609 for filling the clearance is added between the fifth part 607 and the sixth part

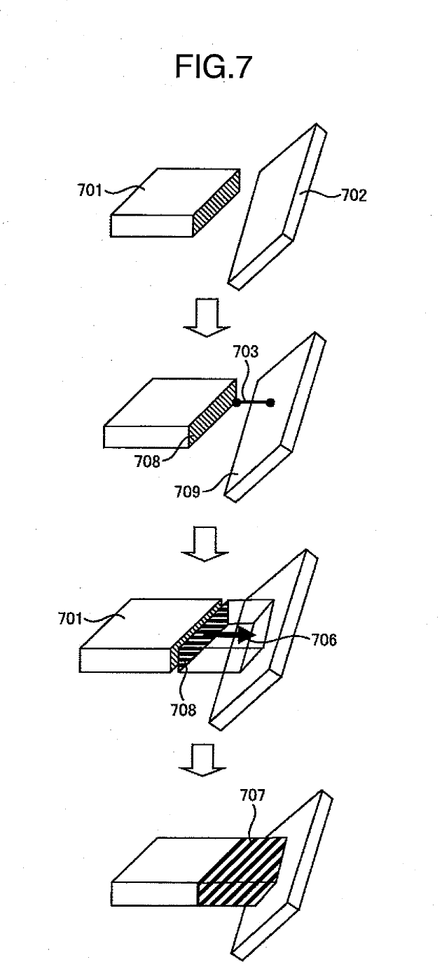

FIG. 7 is a diagram showing an example of a process for creating a virtual shape for filling a clearance. For a clearance present between a first part 701 and a second part 702, a distance between a first face of the first part 701 and a second face of the second part 702 is obtained, and a distance 703 with which the first part 701 and the second part 702 becomes the closest to each other is calculated. Of the first face 708 and the second face 709 between which the shortest distance was calculated, one face is extended to the other face to create a shape. For example, according to one method, the direction with which the face is extended is set as a normal vector direction of the face. According to another method, of the first face 708 and the second face 709, one with a smaller area is extended. According to another method, determination is made as to which face of the second part 702 including the second face 709 the first face 708 will belong to if the first face 708 is extended and connected to the second face 709, and the direction with which the first face 708 should be extended is set. In the case of FIG. 7, the first face 708 is extended in a normal vector direction 706 of the first face 708 to create a virtual shape 707 by way of example.

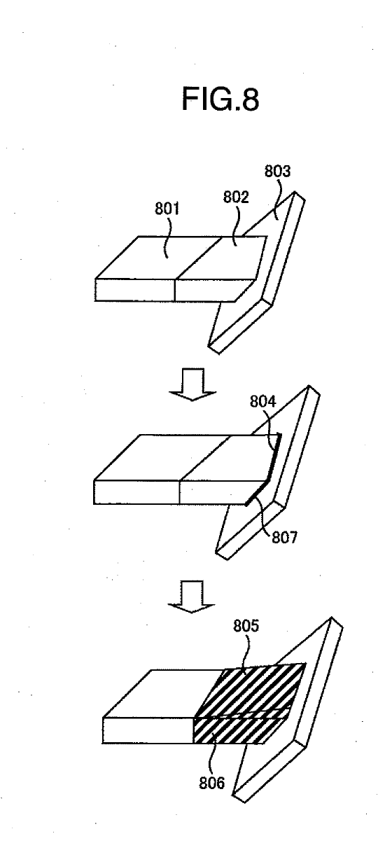

FIG. 8 is a diagram showing an example of a process for producing a welding bead between a first part 801 and a second part 803 after a clearance present between the first part 801 and the second part 803 is filled with a virtual shape 802. After the virtual shape 802 is added, the first part 801 and the second part 803 are bonded and formed into one part. After that, shared lines between a first face of the first part 801 and a second face of the second part 803 on which a welding bead should be produced are retrieved based on the angle between the first face and the second face. Based on highlight-displayed retrieval results 804 and 807, welding bead shapes 805 and 806 are produced on the shared line. The leg length of the welding bead is set as the welding bead is produced. In addition, welding attribute information such as material, start position, pitch, etc. can be set when the shape of the welding bead is produced or after the welding bead is produced. CAD data can be created by giving a shape to the welding bead. Thus, mesh division and boundary conditions are added to the CAD data to create an analytical model.

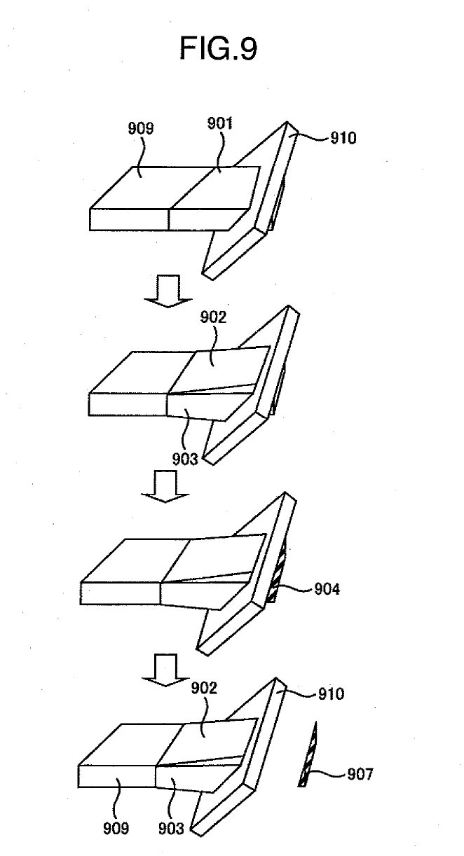

FIG. 9 is a diagram showing a method for deleting a virtual shape when the virtual shape is present outside a virtual shape 901, a first part 909 or a second part 910 after a clearance is filled with the virtual shape and a welding bead is produced. The virtual shape 901 is created between the first part 909 and the second part 910. When the virtual shape 901 is added, one of faces of the first part 909 is extended to a face of the second part 910. When the virtual shape 901 is created thus, the virtual shape 901 may be created to protrude over the second part 910, for example, if the second part 910 is too thin. In this state, welding bead shapes 902 and 903 are produced in the place where the welding bead should be produced. After the welding bead shapes 902 and 903 are produced, whether a virtual shape 904 protruding over the second part 910 is outside the welding bead shapes 902 and 903 or not is determined in accordance with whether there is or not a face having a shared plane between the virtual shape 901 and the welding bead shape 902 or 903 or between the virtual shape 901 and the second part 910. When there is at least one face having no shared plane, determination is made that the virtual shape protrudes outside the first part 909 or the second part 910, and the shape is divided by the shared plane between the virtual shape 901 and the welding bead, the first part 909 or the second part 910. As for faces forming a virtual shape 907 obtained by the division, determination is made as to whether there is or not a face having no shared plane between the virtual shape 907 and the welding bead shape 902 or 903, the first part 909 or the second part 910. When there is at least one face having no shared plane, data of the virtual shape is deleted.

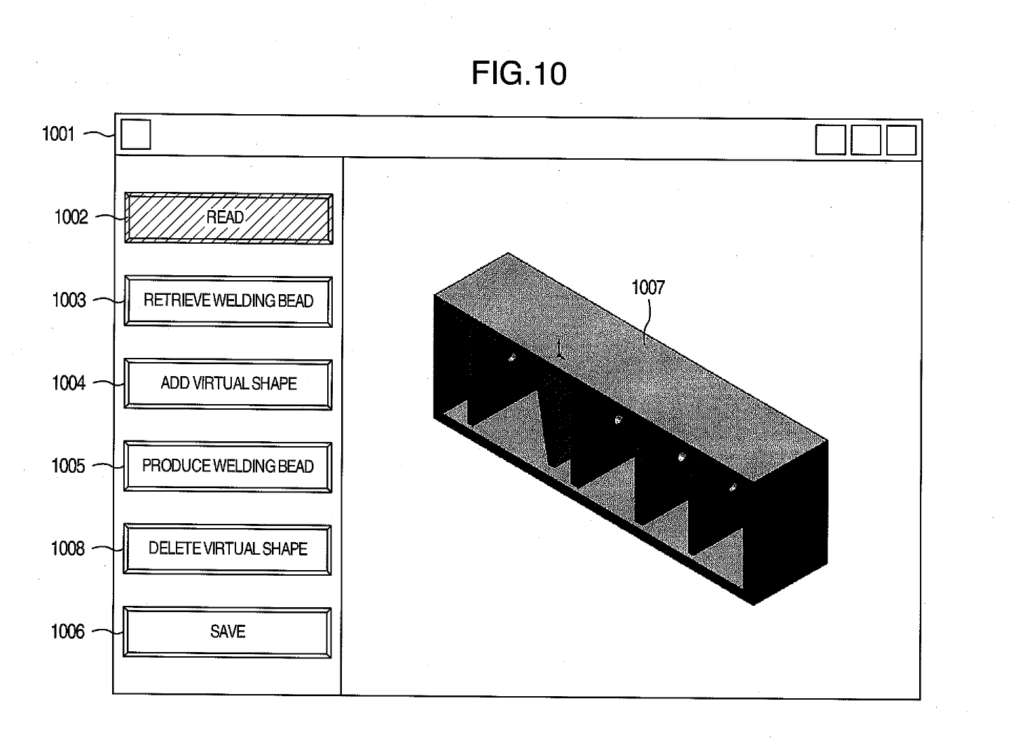

FIG. 10 is a diagram showing an example of an operation screen 1001 for retrieving a place where a welding bead should be produced from CAD data and producing the welding bead on the CAD data. The operation screen 1001 includes a “read” button 1002, a “retrieve welding bead” button 1003, an “add virtual shape” button 1004, a “produce welding bead” button 1005, a “delete virtual shape” button 1008, and a “save” button 1006. When the “read” button 1002 is pushed, CAD data 1007 is displayed.

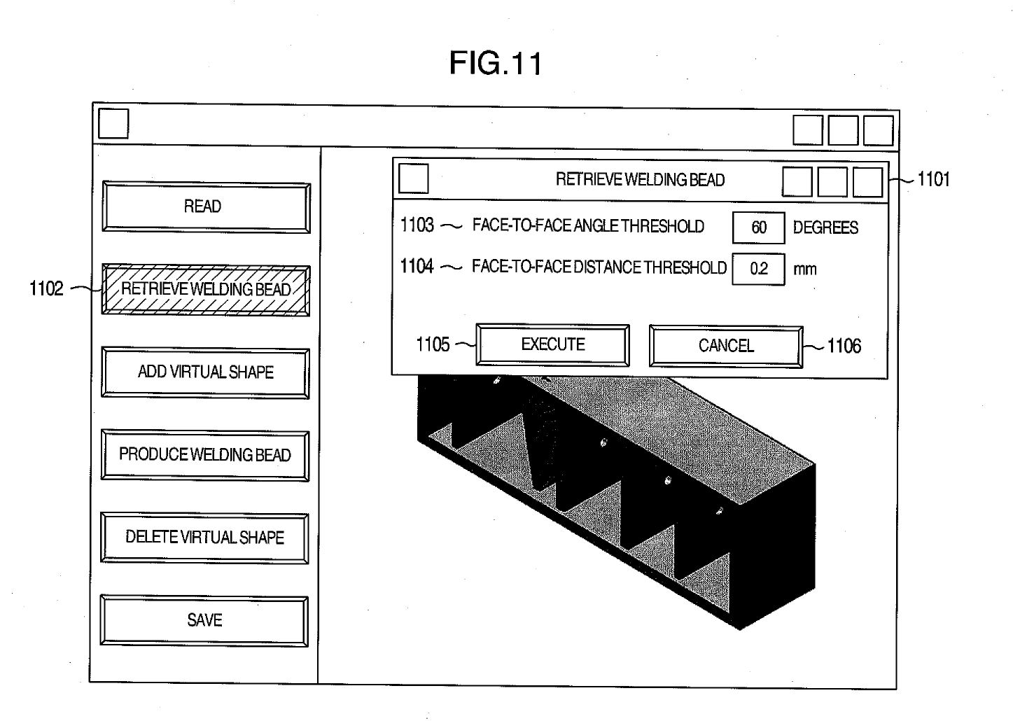

FIG. 11 is a diagram showing an example of an operation screen for a process for retrieving a welding bead. When a “retrieve welding bead” button 1102 is pushed on read CAD data, a screen 1101 for retrieving a place where a welding bead should be produced is displayed. On the screen 1101, a user can set a face-to-face angle threshold 1103 to be compared with an angle between faces of parts in order to retrieve a place where a welding bead should be produced, and a face-to-face distance threshold 1104 to be compared with a calculated face-to-face distance between parts in order to retrieve a clearance. When the user pushes an “execute” button 1105, any place (faces or lines) where an angle between faces is not larger than the face-to-face angle threshold 1103 or a distance between the faces is not larger than the face-to-face threshold 1104 and where a welding bead should be produced is highlight-displayed. When a “cancel” button 1106 is pushed, the retrieval is canceled.

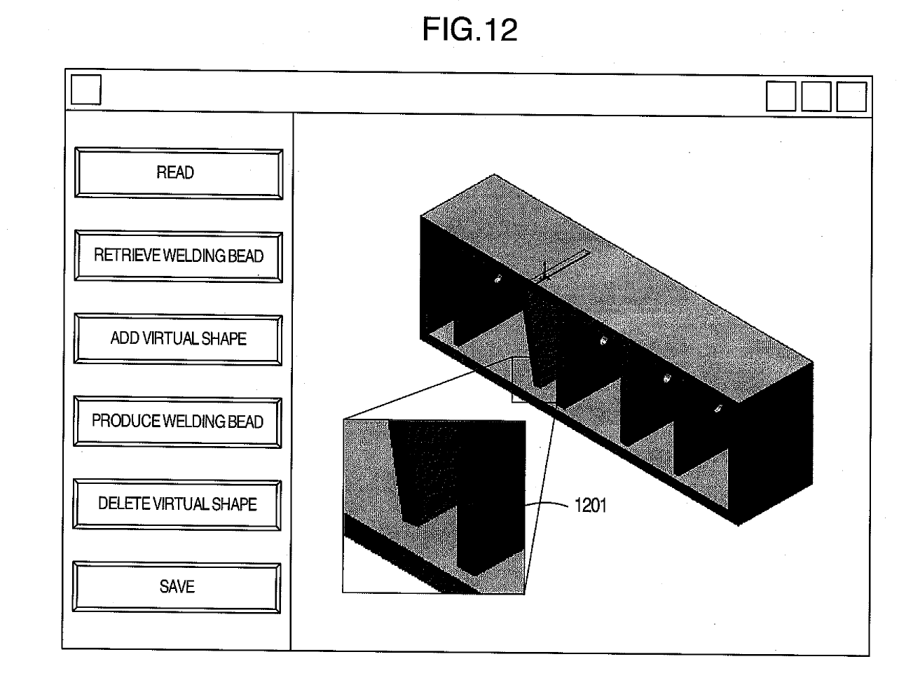

FIG. 12 is a diagram showing an example of a result of execution of welding bead retrieval. As for a place 1201 where parts abut against each other not at right angles but obliquely in a face-to-line manner, a place where a welding bead should be produced is obtained from an angle between faces of the parts and highlight-displayed.

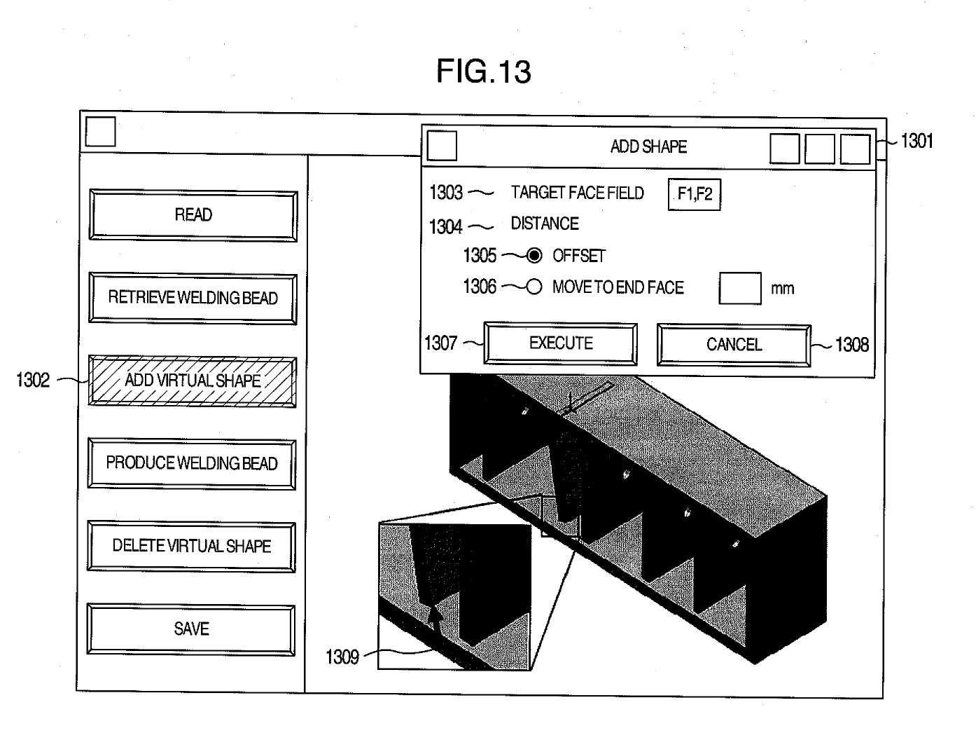

FIG. 13 is a diagram showing an example of an operation screen where a virtual shape is added to a clearance on a result of retrieval where parts are not connected to each other but abut against each other in a face-to-line manner. When an “add virtual shape” button 1302 is pushed, an “add virtual shape” screen 1301 is displayed. On the “add virtual shape” screen 1301, as a result of clearance retrieval, the face number of a highlight-displayed face is displayed in a target face field 1303, and the face is extended to create a virtual shape. To set a distance 1304, a user can select a method 1305 for allowing the user to set the distance 1304 or a method 1306 for extending the face to a face (end face) of the other part. The direction to extend the face is set as a normal vector direction of the selected face. As soon as the “add virtual shape” screen 1301 is started up, the face number of a face found out as a result of welding bead and clearance retrieval is obtained and displayed on the screen. When an “execute” button 1307 is pushed, a virtual shape can be added. In addition, a user can manually select a face where a virtual shape should be added, for example, by use of a cursor 1309 or the like. When a “cancel” button 1308 is pushed, the addition of the shape is canceled.

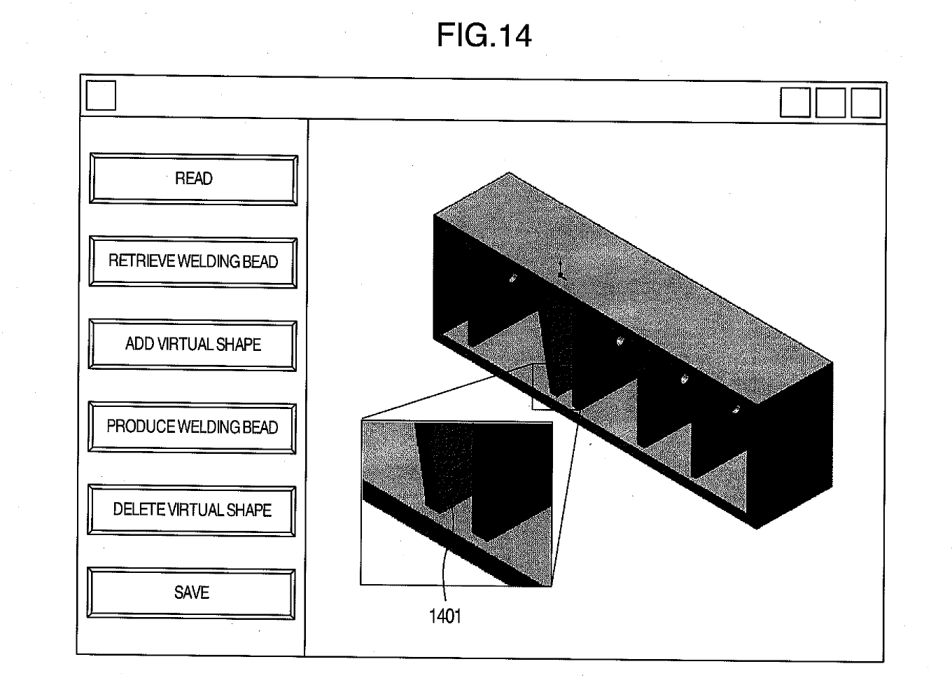

FIG. 14 is a diagram showing an example of a screen where a result of addition of a virtual shape is displayed. When the “execute” button 1307 is pushed on the “add virtual shape” screen 1301 of FIG. 13, a virtual shape 1401 is added.

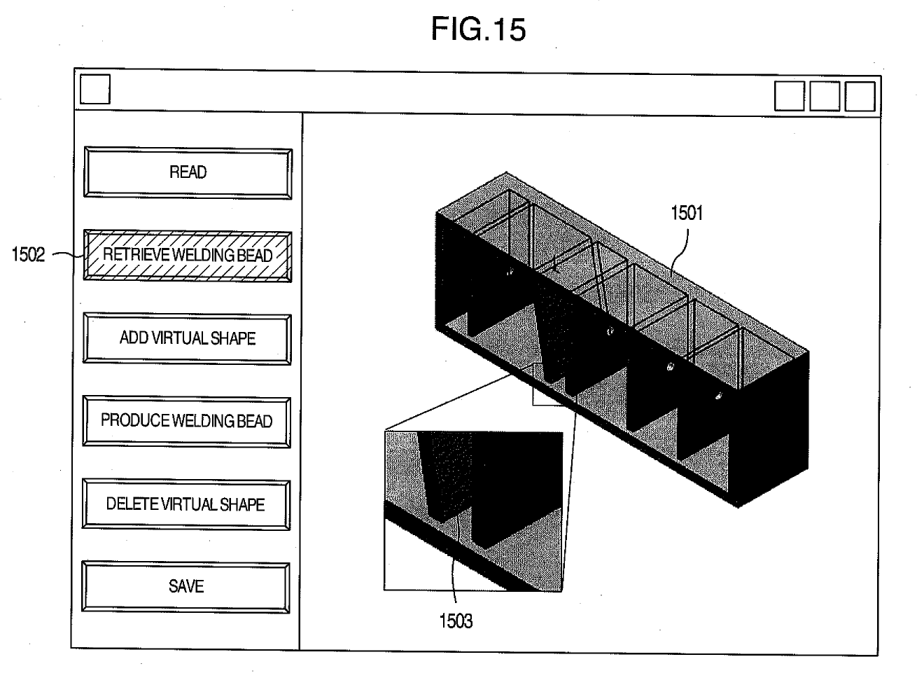

FIG. 15 is a diagram showing an example of a screen displaying a result of retrieval when welding bead retrieval 1502 is executed again after a virtual shape is added. A place 1503 where a welding bead should be produced is highlight-displayed on CAD data 1501.

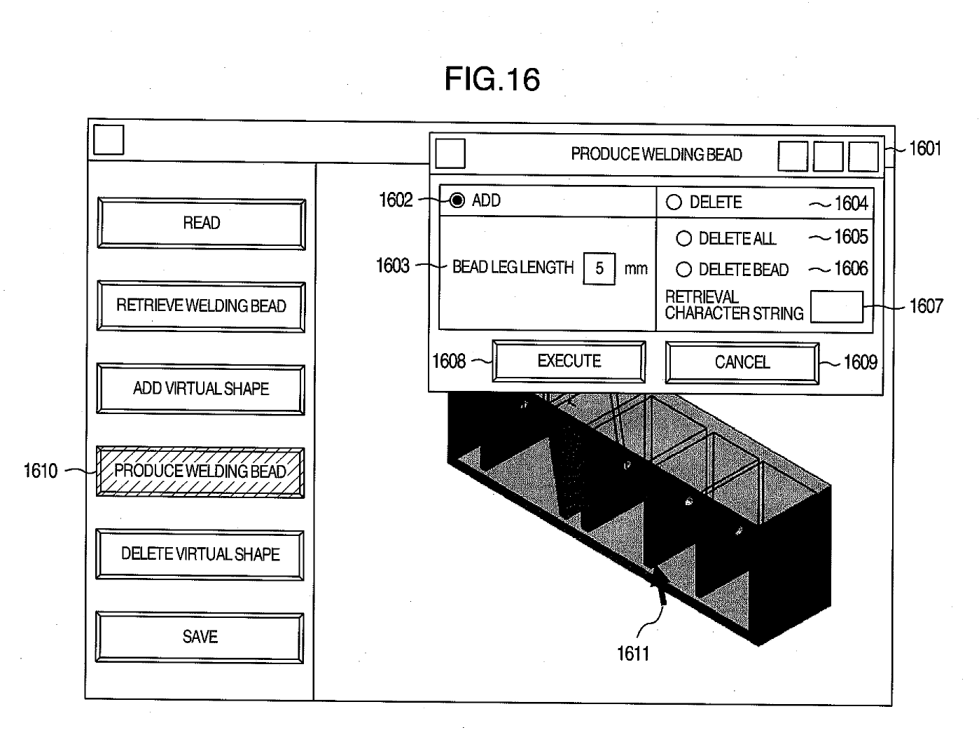

FIG. 16 is a diagram showing an example of an operation screen for producing a welding bead based on a result of retrieval of a place where the welding bead should be produced. When a “produce welding bead” button 1610 is pushed, a “produce welding bead” screen 1601 is started up. When an “add” button 1602 is pushed to produce a welding bead, the screen is brought into a state where the welding bead has been produced. When a bead leg length 1603 is inputted and an “execute” button 1608 is pushed, the welding bead is produced. A “delete” button 1604 for deleting a produced welding bead is prepared on the “produce welding bead” screen 1601. When the button 1604 is pushed, the welding bead is deleted. When a “delete all” button 1605 for deleting all the produced welding beads is pushed and the “execute” button 1608 is pushed, all the welding beads are deleted. In addition, the name of a welding bead to be deleted can be selected from the names of welding beads and inputted into a retrieval character string 1607. In this case, when a “delete bead” button 1606 is selected and the “execute” button 1608 is pushed, the welding bead is deleted. When a “cancel” button 1609 is pushed, welding bead production is canceled.

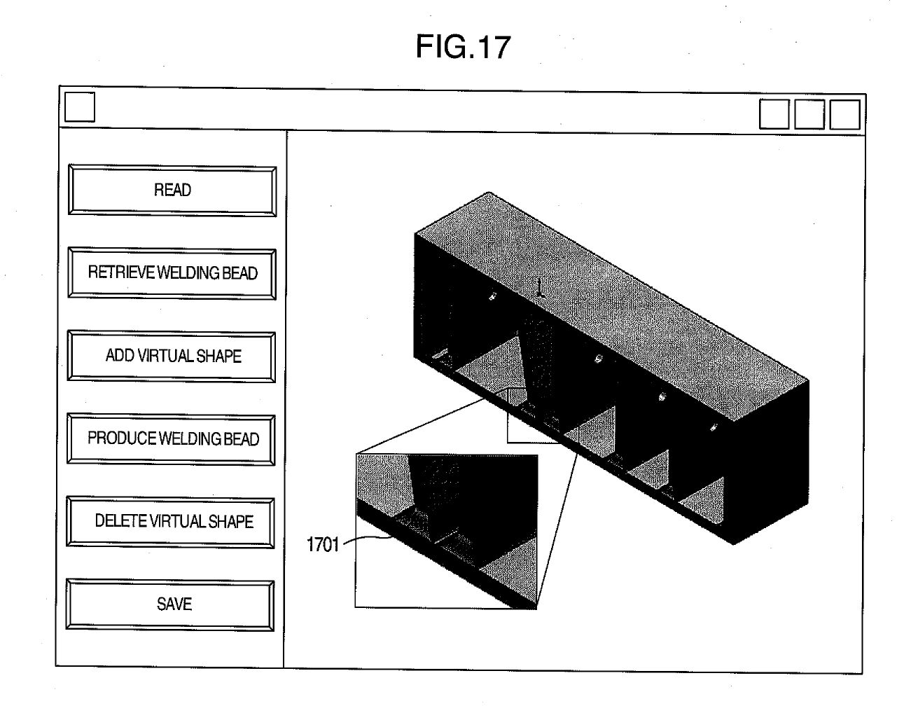

FIG. 17 is a diagram showing an example of a screen displaying a result of welding bead production. When welding bead production is executed on the “produce welding bead” screen 1601 of FIG. 16, a welding bead shape 1701 with a specified bead leg length is produced on a line to be welded.

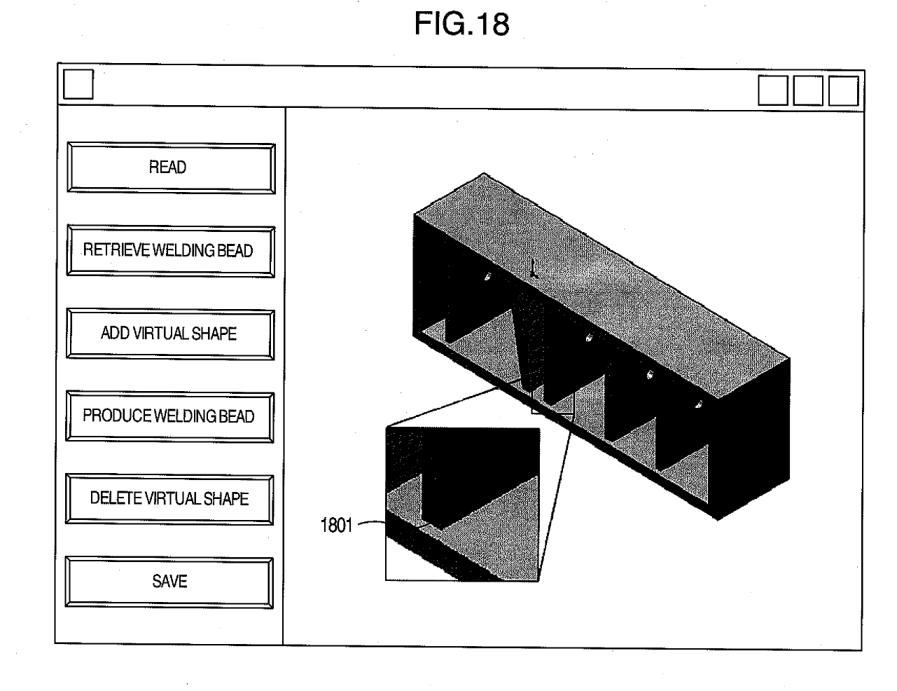

FIG. 18 is a diagram showing an example of a screen displaying a result of deletion of all welding beads. In the example, all welding beads have been deleted from a place 1801 where the welding beads were produced.

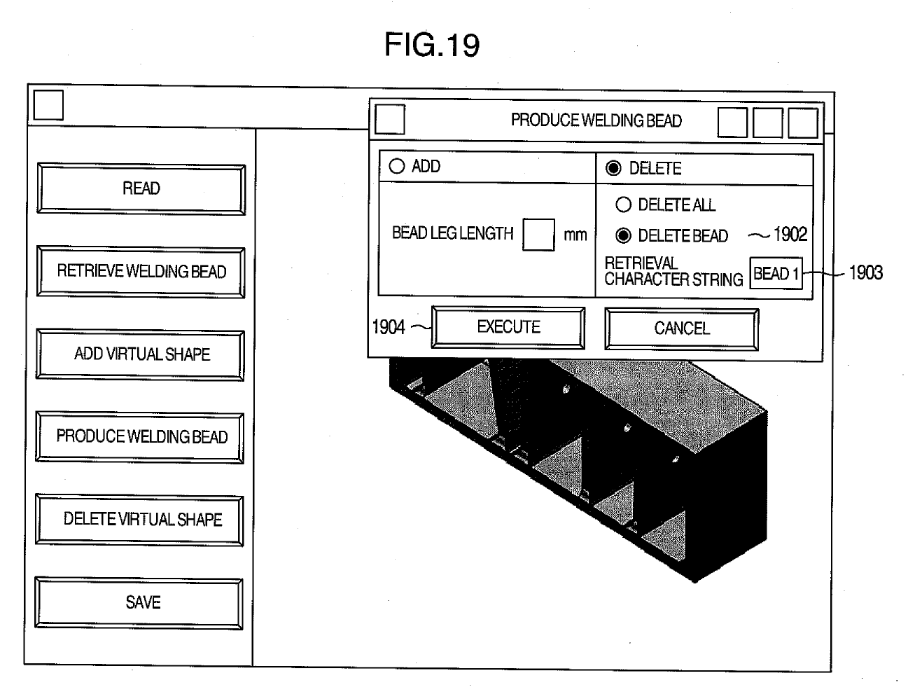

FIG. 19 is a diagram showing an example of a screen for deleting a welding bead to be deleted, where the welding bead is deleted after the name of the welding bead is inputted into a retrieval character string 1903. A “delete bead” button 1902 is selected and “bead 1” is inputted into the retrieval character string of a welding bead name. When an “execute” button 1904 is then pushed, a welding bead whose name corresponds to “bead 1” is deleted.

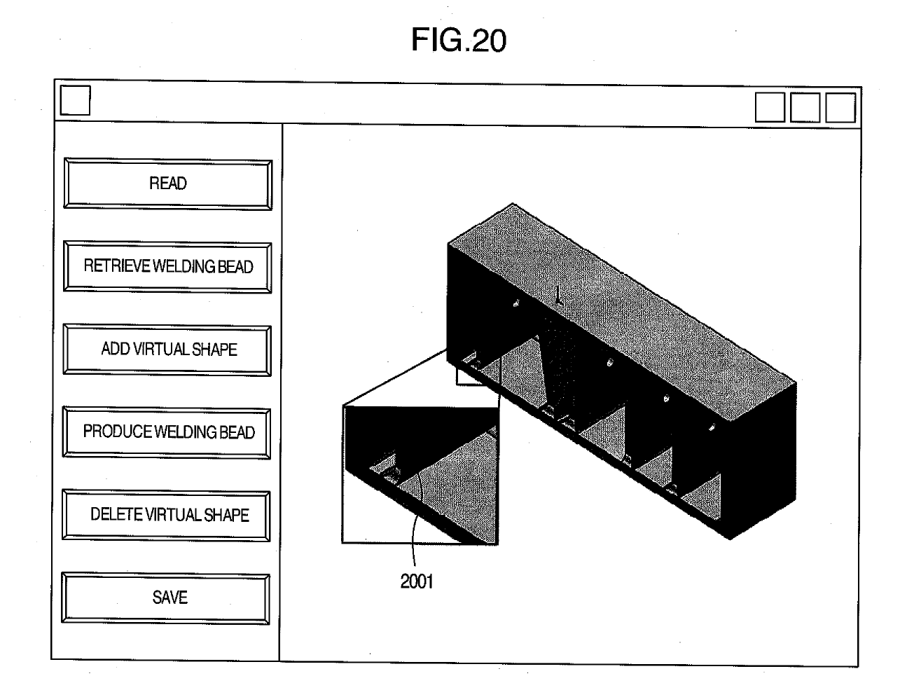

FIG. 20 is a diagram showing an example of a screen showing a result of deletion of a welding bead corresponding to a welding bead name. A welding bead 2001 whose welding bead name is “bead 1” is deleted.

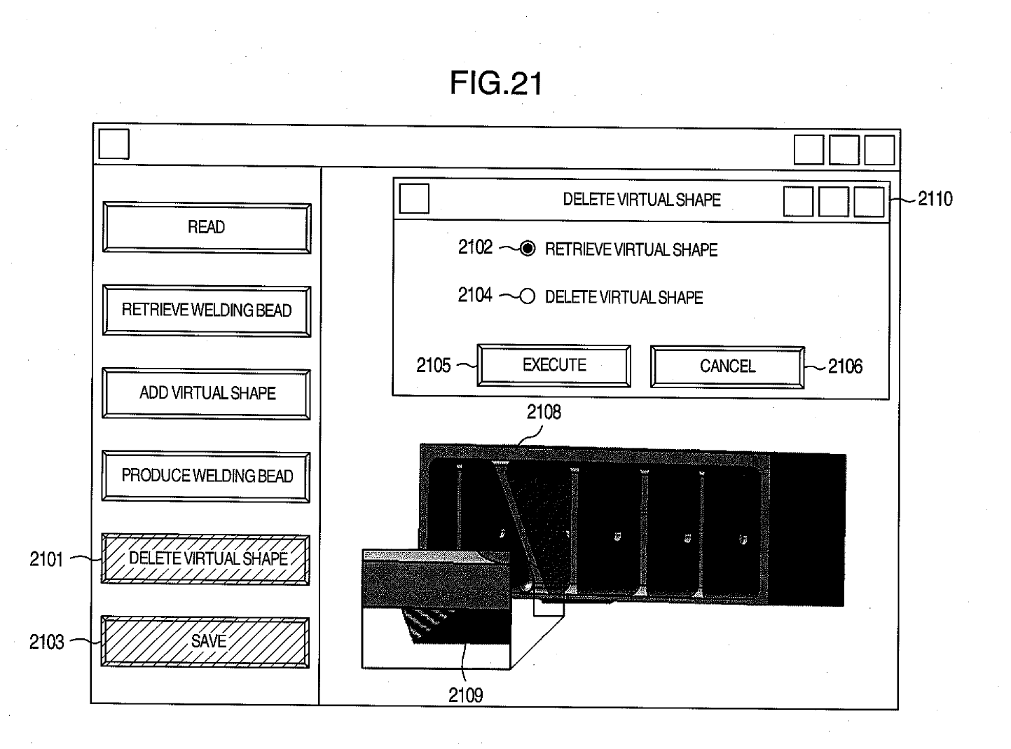

FIG. 21 is a diagram showing an operation screen for deleting a virtual shape. When a “delete virtual shape” button 2101 is pushed after a welding bead is produced, determination is made as to whether each face forming the virtual shape has a shared plane with the welding bead and CAD data or not. When a “retrieve virtual shape” button 1202 constituting a “delete virtual shape” screen 2110 is selected and an “execute” button 2105 is pushed, of the virtual shape, a part 2109 of the virtual shape protruding outside is highlight-displayed. In the highlight-displayed state, when a “delete virtual shape” button 2104 is selected and the “execute” button 2105 is pushed, the highlight-displayed part 2109 protruding outside is divided by the shared plane with the welding bead and the CAD data, and the virtual shape is deleted. When a “cancel” button 2106 is pushed, the process of virtual shape deletion is canceled. When a “save” button 2103 is pushed, data of the result is saved.

According to the first embodiment described above, it is possible to provide an analytical model generating apparatus which can shorten the work time for producing a welding bead. In addition, CAD data including not only design information but also processing information is created so that unified data can be managed. Thus, as compared with the case where welding information is specified on drawings, management becomes easier, leading to reduction in the number of drawings and prevention of a wrong production instruction.

In addition, according to the first embodiment, in 3D CAD data for design, where parts abut against each other in a face-to-line manner or there is a clearance between the parts, a place where the parts abut against each other in a face-to-line manner and presence/absence of the clearance between the parts are retrieved, and the clearance is filled with a virtual shape. CAD data for design is first read, and a place where welding information should be created is retrieved based on an angle between constituent faces of a shape. A pair of faces where an angle between the faces is smaller than a threshold specified by a user is retrieved.

When a place to be welded is retrieved, not only the angle but also a face-to-face distance between shapes are obtained. When the distance is within a threshold, determination is made that there is a clearance where welding should be produced. After a virtual shape is added to fill the clearance, a welding bead is produced. After the welding bead is produced, unnecessary parts of the virtual shape are deleted. Alternatively, when the virtual shape protrudes outside a real shape, protruding parts of the virtual shape are deleted, and a result of welding bead production is displayed.

It should be further understood by those skilled in the art that although the foregoing description has been made on embodiments of the invention, the invention is not limited thereto and various changes and modifications may be made without departing from the spirit of the invention and the scope of the appended claims.

1. An analytical model generating apparatus comprising:
an input portion which inputs CAD data describing at least a first part and a second part, face-to-face angle threshold data, face-to-face distance threshold data, and leg length data of a welding bead;
a CAD data reading portion which reads the CAD data;
a welding bead retrieving portion which compares an angle between the first part and the second part with the face-to-face angle threshold data so as to retrieve a place where the welding bead should be produced;
a clearance check portion which compares a distance between the first part and the second part with the face-to-face distance threshold data;
a virtual shape creating portion which creates a virtual shape in the clearance between the first part and the second part based on comparison results of the welding bead retrieving portion and the clearance check portion;
a welding bead producing portion which produces the welding bead in the virtual shape based on the leg length data of the welding bead; and
a CAD data saving portion which saves CAD data including the produced welding bead.

2. An analytical model generating apparatus according to claim 1, wherein:
the virtual shape creating portion extends one of a first face of the first part and a second face of the second part to the other so as to create the virtual shape.

3. An analytical model generating apparatus according to claim 1, further comprising:
a virtual shape deleting portion which deletes at least a part of the virtual shape located outside the produced welding bead when at least the part of the virtual shape is located outside the welding bead.

4. An analytical model generating apparatus according to claim 2, further comprising:
a virtual shape deleting portion which deletes at least a part of the virtual shape located outside the produced welding bead when at least the part of the virtual shape is located outside the welding bead.

5. An analytical model generating apparatus according to claim 1, wherein:
the welding bead retrieving portion retrieves the angle between the first part and the second part based on an angle between a first face of the first part and a second face of the second part.

6. An analytical model generating apparatus comprising:
a CAD data reading portion which reads CAD data;
a welding bead retrieving portion which retrieves, from the CAD data, a place where a welding bead should be produced;
a clearance check portion which checks whether there is or not a clearance in the retrieved place where the welding bead should be produced;
a virtual shape creating portion which creates a virtual shape in the clearance;
a welding bead producing portion which produces the welding bead in the virtual shape; and
a CAD data saving portion which saves CAD data including the produced welding bead.
